(19) United States
(12) Patent Application Publication
(10) Pub. No.: US 2003/0174832 A1
(43) Pub. Date: Sep. 18, 2003

(54) Phone battery devices

(76) Inventor: David Andrew Pearson, Hunt. Bch., CA (US)

Correspondence Address: DAVID PEARSON, 22102 CAPE MAY LANE, HUNTINGTON BEACH, CA, 92646, US

(21) Appl. No.: 10/096,975

(22) Filed: Mar. 14, 2002

(51) Int. Cl. H04M 1/00

(52) U.S. Cl. 379/413

(57) ABSTRACT

Battery operated devices can be redesigned to use a cordless telephone battery. A battery back-up system that uses a battery for battery operated devices is also presented. Also included is an adapter to change the type of connecter on a cordless telephone battery.

### REFERENCES CITED

U.S. Pat. No. 5,384,207 1/95 OHTANI 429/9,99,100

1. Field: Technical

This invention relates to battery technology.

2. Prior Art

The battery (part number 22) that is used in 5,384,207 is not a conventional phone battery. The new invention uses a conventional phone battery.

It is not communicated in that patent that the devices listed are to be modified to use a conventional phone battery or that the phone is to be used as a charger. The concept of building a device, other than a phone, that uses a conventional phone battery is not present in that patent. Such a concept as considered obviously successful would be communicated. Further, it is clear that said concept is not obvious to those who are skilled in the art that are familiar with that patent as ample time has gone by for those who are skilled in the art to become familiar with it and still it is not present in the prior art.

Currently, backup batteries are used in clocks. Such devices use A.C. as opposed to batteries as a primary power source. The new invention introduces the use of a built-in back-up battery system with a device that uses a battery as a primary power source. The back-up battery system of 5,384,207 is removable as opposed to built-in.

### BRIEF SUMMARY

Devices built to use a cordless/wireless telephone battery so that the telephone can be used as a charger. This concept also provides a convienent back-up battery for the devices and the telephones: The batteries can be swapped between them for the device that is most needed if one of the batteries becomes expended.

Also included is a built-in back-up battery system and an adapter for the phone battery connecters.

### BRIEF DESCRIPTIONS OF THE DRAWINGS

FIG. 1 is a side internal view. FIG. 2 is a top cut-away view. FIG. 3 is a top view. FIG. 4 is a bottom view. FIGS. 5 and 6 are top cut-away views. FIG. 8 is a side view. FIG. 9 is a front view.

### DETAILED DESCRIPTIONS OF THE DRAWINGS

The points between wires, switch leads and other conducters are representations of soldered electrical contacts. All wires can be ridged wires.

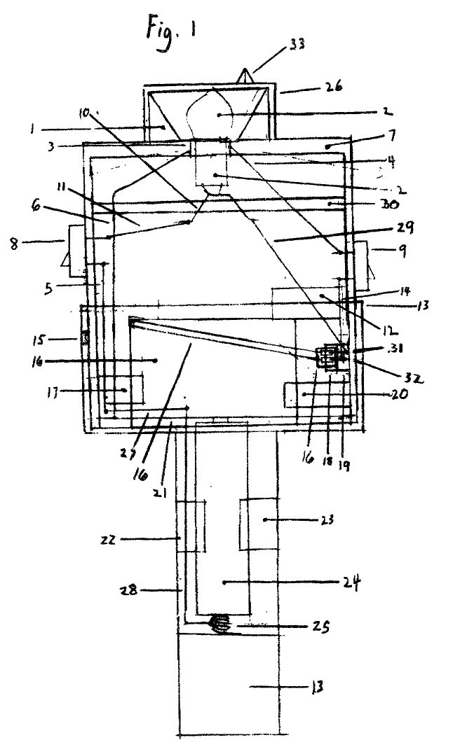

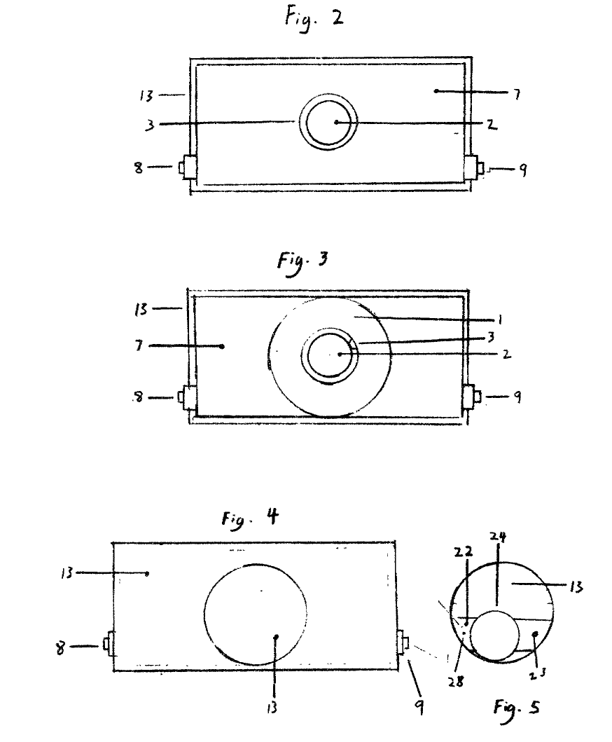

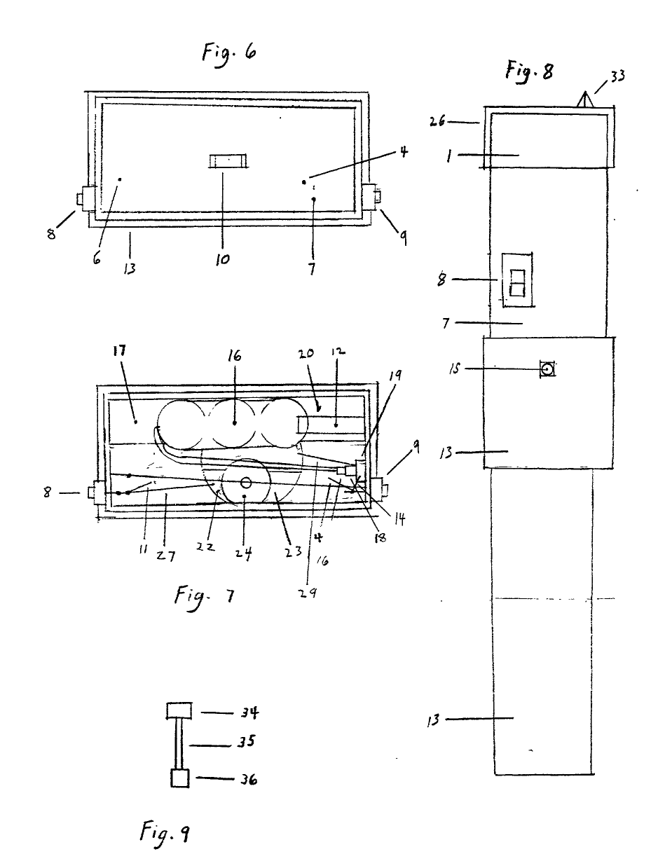

FIGS. 1-8 illustrate an example of a device that is built to use a cordless telephone battery. A back-up system that uses a conventional battery is illustrated as part of the device. It consists of part numbers 5,6,8,11,22-25,27 and 28. The back-up system is optional. It is intended that it is not to be limited in the type of battery(s) that it uses. This includes the use of additional telephone batteries and multiple batteries (of different types). An embodiment of this invention is devices with or without a back-up system that are built to use a conventional cordless/wireless telephone battery.

FIG. 9 illustrates the phone battery adapter.

1. Reflecter can be a piece of plastic with a mirror finish.

2. lightbulb can be a flashlight bulb.

3. Light bulb ring can be a piece of metal. It can be glued into the encasement. It can be of a size that generates a snug fit with the lightbulb. The lightbulb can be held in place and an electrical connection can be formed between the two parts by the fit.

4. Wire one can be a wire. One end of it is soldered onto the upper switchlead of switch one. The other end of it is soldered onto the lightbulb ring. It is ran through the platform 30 to get between the two parts.

5. Wire 2 can be a wire. One end of it is soldered onto the bottom switchlead of swith two. The other end of it is soldered onto wire seven.

6. Wire three can be a wire. One end of it is soldered onto wire six. The other end of it is soldered onto the lightbulb ring.

7. Encasement can be a piece of plastic.

8. First switch can be a rocker switch. It can open or close the back-up circuit to send energy from the back-up battery 24 to the lightbulb. The back-up circuit consists of part numbers 2,3,5,6,8,11,22-25,27 and 28. It can also increase brightness for the lightbulb.

9. Second switch can a rocker switch. It can open or close the primary circuit to send energy from the phone battery to the lightbulb. The primary circuit consists of part numbers 2-4, 9, 10, 14, 16, 18, 19, 29, 31, and 32.

10. Negative contact can be a piece of metal. It is inserted through the platform and glued in place. When the lightbulb is inserted, the bottom of it comes into contact with the negative contact and an electrical connection is formed.

11. Wire four can be a wire. One end of it is soldered onto the upper switchlead of switch two. The other end of it is soldered onto the negative contact.

12. Battery positioner can be a piece of plastic. It can be glued into the inside of the encasement. The phone battery comes into contact with it when installed.

13. Handle can be a piece of plastic. It can be flexible enough so that it can be slid over the knob with moderate pressure. It can be of a size that generates a snug with the encasement.

14. Wire five can be a wire. One end of it is soldered onto the lower switchlead of switch one. The other end of it is soldered onto the upper recepticle lead.

15. Knob can be a bump on the encasement. It can be used to hold the handle onto the encasement.

16. Phone battery can be a conventional battery for a cordless telephone. It is expected that the device can be built to use one or more phone batteries.

17. First battery holder can be a piece of plastic. It can be glued into the encasement.

18. Battery recepticle can be a piece of plastic. It can be in the shape of a conventional cordless telephone battery recepticle. It can be slide over the recepticle leads and glued onto the recepticle mount. The connecter of the phone battery can be plugged into or unplugged from from it. It is expected that one or more different types of phone battery recepticles can be built-in to increase compatibility with telephone batteries

19. Recepticle mount can be a piece of plastic. The recepticle leads can be glued into it and it can be glued into the encasement.

20. second battery holder can be a piece of plastic. The phone battery can fit snugly imbetween the first and second battery holders. The phone battery can be held in place by the battery positioner and the and the first and second battery holders.

21. Wire six can be a wire. each end of it is embedded embedded into the encasement. When the handle is installed, the positive terminal of the back-up battery 24 comes into contact with it.

22. First back-up battery holder can be a piece of plastic. It can be glued into the handle.

23. Second back-up battery holder can be a piece of plastic. The back-up battery can fit snugly imbetween the first and second back-up battery holders.

24. Back-up battery can be a battery. When installed into the handle, the negative terminal comes into contact with the spring 25 and an electrical connection is formed.

25. Spring can be a metal spring. It can be glued into the handle.

26. Cap can be a clear or translucent piece of soft plastic. It can be of a size that generates a snug fit with that reflecter. It can be held in place by the fit. Colors can be variable or it can be without color. As an embodiment of a harder piece of plastic, it can be rotated to change the color effect of the output if it is also in an embodiment of multiple colors.

27. Wire seven can be a wire. One end of it is soldered onto wire two. The other end of it is soldered onto wire eight 28.

28. Wire eight can be a wire. One end of it is soldered onto wire seven. The other end of it is soldered to the spring.

29. Wire nine can be a wire. One end of it is soldered onto the negative terminal. the other end of it is soldered onto the negative contact. It is ran through the recepticle mount to get between the towo parts.

30. Platform can be a piece of plastic. It can be glued into the encasement.

31. Negative recepticle lead can be a piece of metal.

32. Positive recepticle lead can be a piece of metal. The connecter of the phone battery can be plugged into the battery recepticle to form an electrical connetion between the battery terminals and the recepticle leads.

33. Diffracter can be a (multi)(-)(colored) piece of clear plastic. It is expected that one or more diffractors can be built onto a device for the purpose of diffracting light. It can be part the cap. It can be used to diffract light. Size and shape can be subject to change.

34. Phone battery adapter recepticle can be a recepticle for a cordless telephone battery. The type of recepticle is subject to change. The phone battery adapter can be built with one or more phone battery adapter recepticles (of different types).

35. Wires can be insulated wires. They can connect the phone battery adapter recepticle(s) to the phone battery adapter connecter(s) 36.

36. Phone battery adapter connecter can be a cordless telephone battery connecter. The type of connecter is subject to change. The phone battery adapter can be built with one or more phone battery adapter connecters (of different types).

Removable, rechargable batteries for devices other than a cordless telephone can be subtituted for the cordless telephone battery for the proposed devices.

It is intended that all battery operated devices (excluding telephones) are included as devices to be redesigned to use a cordless telephone battery.

1. Battery operated devices (other than phones) that are designed to work with conventional cordless telephone batteries.

2. Battery operated devices that are designed with a built-in battery back-up system.

3. An adapter for a cordless/wireless telephone battery that can change the connecter on the battery.
